(19) United States
(12) Patent Application Publication
(10) Pub. No.: US 2006/0253486 A1
(43) Pub. Date: Nov. 9, 2006

(54) Method and apparatus to assist in the manipulation and understanding of marketing data

(76) Inventor: David Churchill Ford, Minneapolis, MN (US)

Correspondence Address: MERCHANT & GOULD PC, P.O. BOX 2903, MINNEAPOLIS, MN, 55402-0903, US

(21) Appl. No.: 11/123,361

(22) Filed: May 6, 2005

(51) Int. Cl. G06F 7/00

(52) U.S. Cl. 707/102

(57) ABSTRACT

A computer implemented system for performing a method of preparing and presenting marketing data in a customized format to users of marketing data. The system includes an extractor module that provides for the identification, selective extraction and storing of marketing data, an analysis module for the processing of the user identified marketing data and a presentation module.

### TECHNICAL FIELD

This invention relates to marketing data analysis systems. In addition, the invention relates to a system and method for analyzing marketing data and assisting a user in understanding that data.

### BACKGROUND

The sources of marketing information about an industry create new challenges for business managers, such as what data to look at, how to interpret it, and how to draw conclusions that will drive actions that benefit a business. For example, marketing data for the grocery industry includes as many as 185 retail chains with more than 52 market projections available, and new marketing data has been recently added. The marketing data may span for several years, and data based on the uniform product code (UPC) may be subtotaled by brand, count, and flavor, as well as by item, manufacturer, and segment. A medium-sized category of data may have 1,000 or more subtotals to pick from. Finally, up to 300 pre-calculated measurers are provided to assist in the extraction of the data, but the descriptions are often overly technical and concise.

By way of example, the consumer packaged goods industry, in which marketing data is readily available from vendors such as IRI, ACNielsen, and EMS, as well as directly from retailers, includes data that is normally organized around 4 keys that uniquely identify a specific piece of data. These keys are: market (e.g., the grocery store on 123 Main Street), the period (e.g., the 7 days ending Mar. 21, 2000), the product (the UPC sold), and the information of interest (e.g., units sold, price, display, or ad presentation, etc.). This data may reveal insights about the marketplace when properly extracted and analyzed. However, given the volume of data, complexity enters the picture when trying to analyze the data to provide meaningful summaries.

With the advances in electronic sources adding more detailed, complex, and accessible data, evaluation and interpretation of the marketing data becomes increasingly important. The business decision makers are constantly challenged to use the best information available to make business decisions. However, the gathering, analysis, and presentation of the marketing data increasingly requires expertise and the correct tools to aid in the analysis.

### SUMMARY

A computer implemented system for performing a method of preparing and presenting marketing data in a customized format to users of marketing data. The system provides for the selection of a presentation format for use in creating a marketing report and includes an extractor module, an analysis module and a presentation module. The extractor module provides for the identification, selective extraction and storing of marketing data identified and extracted from a data store. The analysis module provides for the processing of the user identified marketing data in order to generate the marketing report using the presentation format selected. The analysis module also includes a glossary and presentation gallery that provides interactive aid and education to the user on how to interpret the information displayed on the marketing report. These and various other features as well as other advantages of the present invention will be apparent from a reading of the following detailed description and a review of the associated drawings.

### DESCRIPTION OF THE DRAWINGS

FIG. 1 illustrates a computer system according to example embodiment of the present invention;

FIG. 2 shows a marketing report system according to an example embodiment of the present invention;

FIG. 3 depicts a report module according to an example embodiment of the present invention;

FIG. 4 illustrates an objectives module according to an example embodiment of the present invention;

FIG. 5 shows an ad hoc module according to an example embodiment of the present invention;

FIG. 6 is a flow diagram illustrating the logical steps performed by an ad hoc module according to an example embodiment of the present invention;

FIG. 7 illustrates an information module according to an example embodiment of the present invention;

FIG. 8 depicts, in more detail, an information module in accordance with an example embodiment of the present invention;

FIG. 9 provides a flow diagram depicting the general logical steps performed by a marketing report system in accordance with an example embodiment of the present invention;

FIG. 10 illustrates a flow diagram for generating one or more marketing reports in accordance with an exemplary embodiment of the invention; and

FIG. 11 illustrates a method for accessing marketing data according to an exemplary embodiment of the invention;

### DETAILED DESCRIPTION

In accordance with the exemplary embodiments disclosed below, a marketing data presentation and analysis system is provided that functions to assist a user in extracting, analyzing, and presenting in a usable format the vast amount of marketing data available today. Marketing data is herein defined to include, but not be limited to, syndicated data related to one or more products, including data from such providers as IRI ACNielsen, and ems relevant to the consumer packaged goods industry. The marketing data presentation and analysis system analyzes marketing data and generates one or more marketing reports concerning the data analyzed, as well as provide analysis tools such as a glossary and chart gallery. A marketing data presentation and analysis system according to the invention may also include additional information to aid the user in understanding and interpreting the data and marketing reports provided. In this manner, the invention may aid the user in extracting the marketing data and understanding why the data is important to a business decision. The user may spend less time reviewing, extracting, formatting, and learning and more time evaluating and making important business decisions.

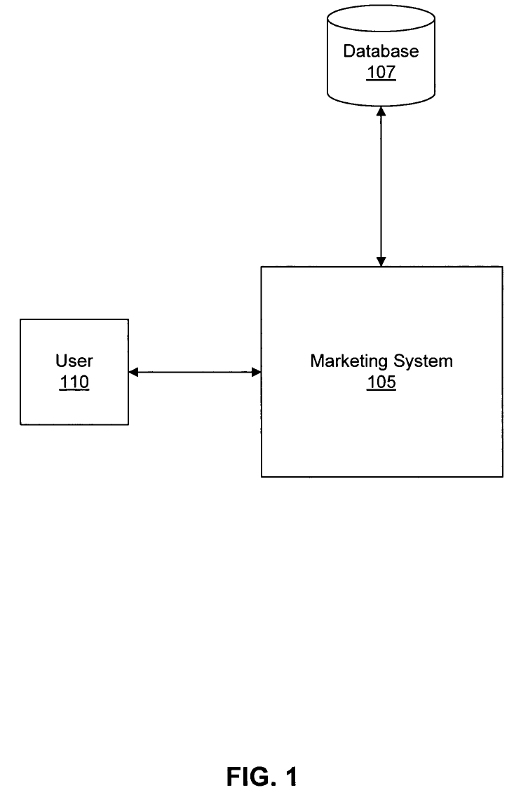

In FIG. 1, an environment is provided in accordance with an exemplary embodiment of the invention including a marketing data presentation and analysis system 105, database 107, and user 110. The database 107 includes marketing data that may be available from such vendors as IRI, ACNielsen, and ems. The data may include syndicated scanner data (UPC) and may include such keys as market, period, product, and other information of interest. The database 107 may be implemented integrally as part of the marketing report system 105 itself, or the database 107 may be separate and maintained by a third-party provider.

The marketing data presentation and analysis system 105 is further accessible by the user 110. The user 110 can interact with the marketing data presentation and analysis system 105 so as to cause the system 105 to extract data from the data base 107, analyze that data, and present the data analyzed to the user 110 formatted as marketing reports. The user 110 can further access a plurality of modules within the marketing data presentation and analysis system 105 so as to further educate and assist the user in understanding the marketing data and presentation modules provided. It should be understood that a plurality of users may access the marketing data presentation and analysis system 105 at one time.

The operating environment illustrated in FIG. 1 is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

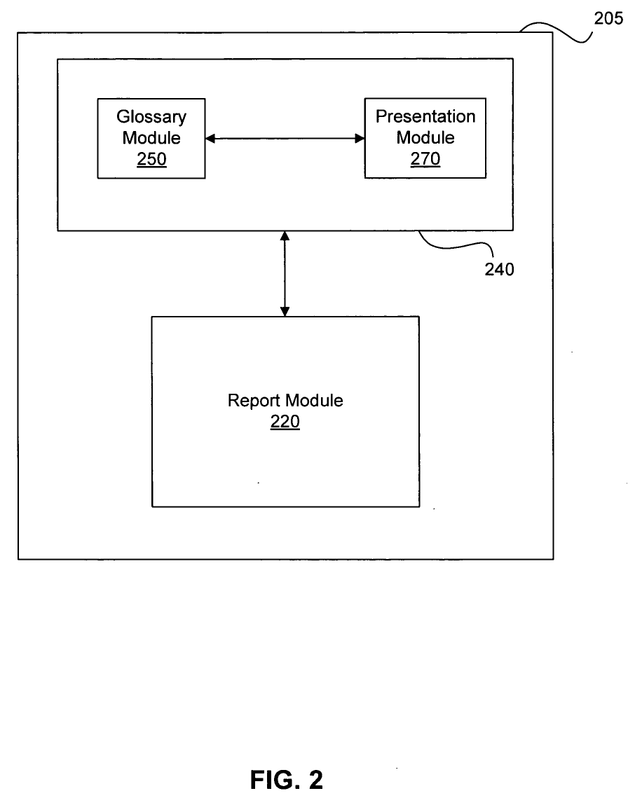

In FIG. 2, a marketing data presentation and analysis system 205 in accordance with another exemplary embodiment of the invention is shown. The marketing data presentation and analysis system 205 comprises a report module 220 and an analysis module 240 including a glossary module 250 and a presentation module 270. The report module 220 includes information specifically tailored to the business objectives of the user, as well as additional information relevant to marketing data generally. The glossary module 250, described in detail below, includes one or more terms that define the information provided within report module 220. The presentation module is comprised of a plurality of presentation formats that may be selected and aids the user in interpreting and presenting the information provided in the report module 220. The presentation module 270 has the ability to automatically create presentation materials from data extracted by the report module 220. The presentation module 270 provides for the presentation of the data extracted by the report module 220 to be presented in a plurality of different pre-defined presentation chart and/or report formats. The analysis module 240 is electronically linked to the report module 220, so as to allow the user of the report module 220 to efficiently access the components of the analysis module 240 while the user examines the information provided in report module 220.

The glossary module 250 may include an extensive list of the terms used within the marketing report system. The glossary terms may comprise terms commonly used in the marketing field, such as syndicated data facts, as well as other terms that may aid the user in interpreting and using the information provided by the marketing report system. Each glossary entry may contain multiple sections including:
Introduction—defines the proper use of the term
Database Term—defines the database tag as used by the user
Definition—provides the calculations necessary to obtain the defined term in prose and further provides the origin of the numbers
Calculation—defines the mathematical representation of the term and further provides examples using real numbers
Caveats—provides limitations of the defined term and its use
Related Measures—provides links to other defined terms that may be of interest to the user
Synonyms—provides business terms or expressions used to describe the defined term
Suggested Charts—provides one or more links to appropriate charts as provided in the chart gallery.

It should be understood by one skilled in the art that additional information relevant to the defined term may be provided and further that not all sections provided above need be included for each defined term. One or more additional electronic links within the glossary are provided to couple related defined terms within the glossary to each other and to further couple defined terms to one or more relevant charts within the presentation module 270.

The presentation module 270 contains a library of presentation chart and/or report formats with instructions on creating and formatting such presentations. Each entry in the presentation module 270 may include the following sections:
Introduction—provides uses for the presentation
Chart—provides sample pictures of the finished chart
Instructions—provides tips on creating and formatting the chart
Spreadsheet—provides underlying data that drives the chart
Format for Charting—provides, if necessary, the additional formatting that must be completed before the chart may be created, including instructions and snapshots.
Suggested Facts—provides links to defined terms in the glossary that may be relevant to the chart.

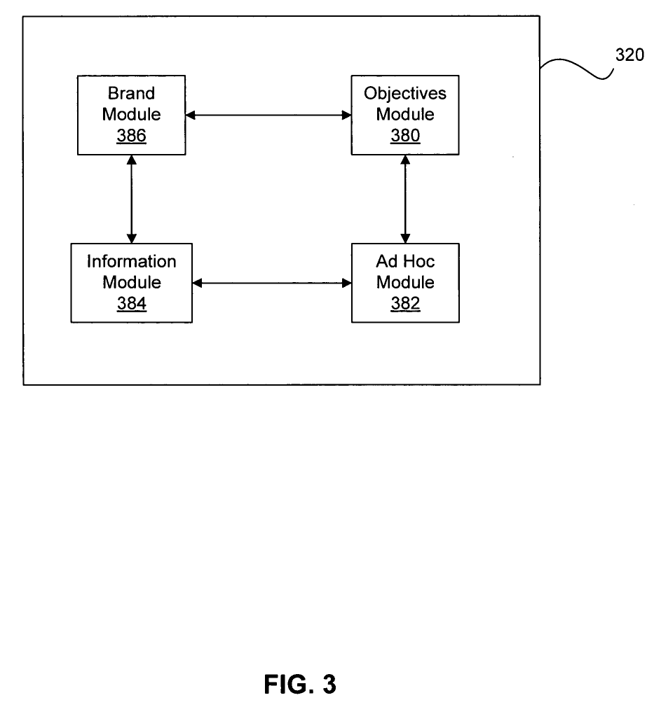

In FIG. 3, a report module 320 in accordance an exemplary embodiment of the invention is shown comprising interconnected modules including an objectives module 380, an ad hoc module 382, an information module 384, and a brand module 386. The brand module 386 may include a plurality of brands as defined and selected by the user. Each brand may be associated with a separate product or different line of goods for the user. The user utilizes the brand module 386 to select a brand from the one or more brands listed, and based on the selected brand one or more business objectives within objectives module 380 and ad hoc queries within ad hoc module 382 may be provided. Further included within the report module 320 is the information module 384, described fully below, which may be accessed by the user so as to provide general and tailored information regarding the marketing data and reports generated by the marketing report system.

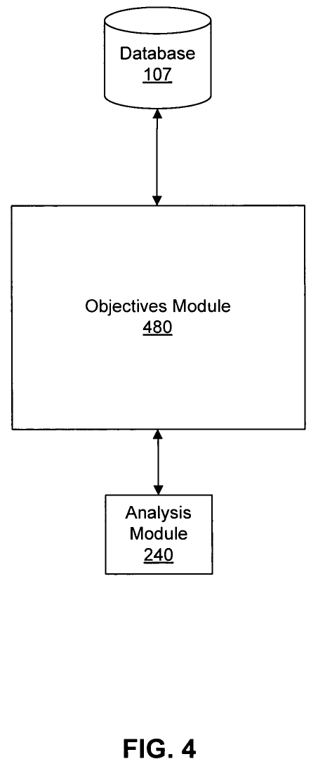

An objectives module 480 is shown in greater detail according to an exemplary embodiment of the present invention in FIG. 4. Further included in FIG. 4 are database 107 and analysis module 240. The objectives module 480 is coupled to database 107 and is further coupled to the analysis module 240. The objectives module 480 includes one or more objectives as defined by the user and tailored to extract, analyze, and present marketing data associated with the objective. An objective may be a business objective, such as, for example, increasing sales through a price decline, and may be specifically tailored to the user's business objectives. When the user accesses the objectives module 480, the objectives module 480 queries database 107 so as to extract the relevant marketing data from the database 107. Further, the user may access the analysis module 240 from within the objectives module 480 via one or more electronic links so as to provide the user with additional information and assist the user in understanding the information provided.

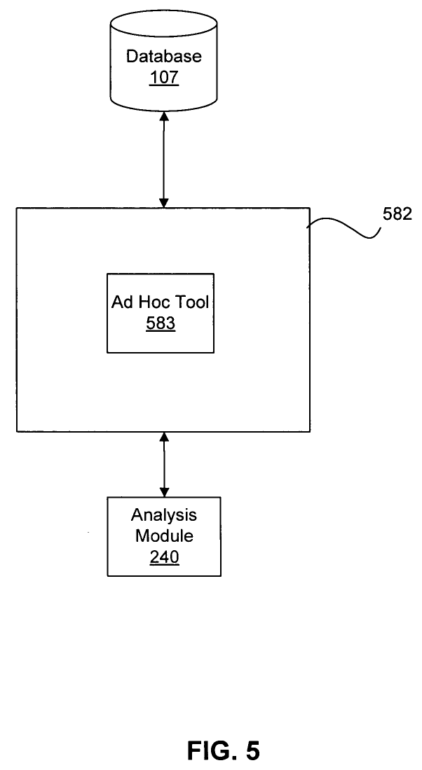

An ad hoc module 582 is depicted in FIG. 5 according to an exemplary embodiment of the invention. Included within the ad hoc module 582 is ad hoc tool 583. Further illustrated in FIG. 5 are communication links between the analysis module 240 and database 107 and the ad hoc tool 583. The ad hoc module 582 provides the user with access to additional marketing data that is contained within database 107 and that is not included as data within an objective as may be defined in an objectives module 480. The ad hoc tool 583 can be used by the user so as to define and execute a query and therefore access additional marketing data from database 107. The analysis module 540 is further available via one or more electronic links.

For example, the ad hoc module 582 may utilize one or more third-party software tools (such as NITE or PFW from ACNielsen; or Analyzer or Accelerate from IRI) or one or more generic SQL based ad hoc query tools (from IBM, Microsoft or others) in order allow the user to define and execute one or more advanced queries. In this manner, the report module 220 provides flexibility in use, allowing the user to gain access and obtain additional marketing data not provided within the objectives defined.

By way of example, assume that a user wishes to determine the yearly sales for product “X”, but the data provided, according to the objectives defined in the objectives module, did not include this information. The user may therefore utilize the ad hoc module 582 so as to define and execute a query to obtain the desired information, in this case the yearly sales for product “X”, from database 107.

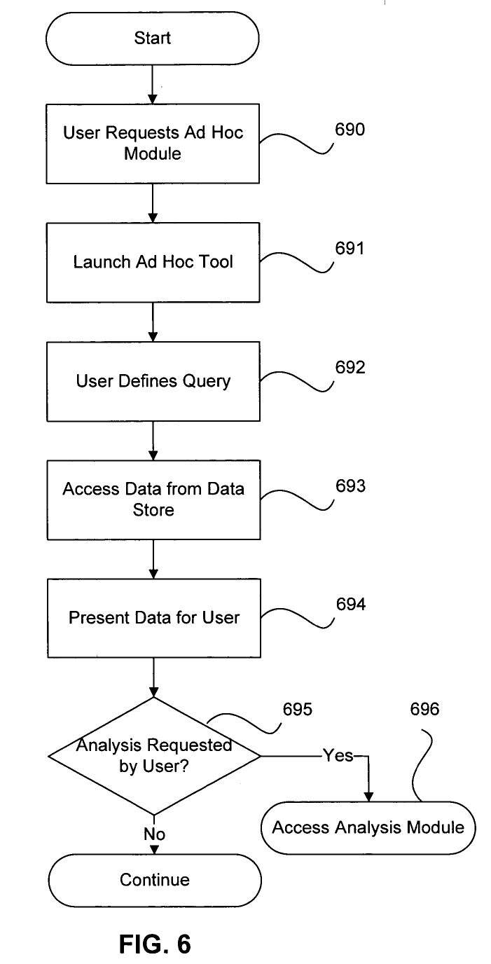

An ad hoc module such as 582 may utilize a logical flow as shown in FIG. 6 according to another exemplary embodiment of the invention. In operation, the user requests the ad hoc module 690, such as the ad hoc module 582 illustrated in FIG. 5. Following the user's request for the ad hoc module, an ad hoc tool is launched 691, such as ad hoc tool 583 illustrated in FIG. 5. Next, the user may define one or more queries as desired 692. The form that the query takes is of critical importance to the marketing professionals success in getting the information desired. The phrase GIGO applies more than ever to ad-hoc query tools.

For example, when looking at a retail price question, the ad hoc tool guides the marketing professional to select price information from market data collected by Scanners at grocery and mass merchandisers or other retail outlets. The alternative consumer based measures will not be as timely or accurate. The subtle differences in the construction of queries are an important value of the ad hoc tool. For example, with price, it is best to select one market channel (such as Grocery, Warehouse Club, Drug, or Mass Merchandiser) from which to retrieve data. Next, select the most recent month for a time period and then compare this time period with the same time period a year ago. (An average price based on 12 months would mask the trend more than a snapshot of the most recent month this year vs. last year.) Next, select the Unit Price measure that does not include any promotion. (This is often called base price or regular price.) Next, select the product so that price is not an average of multiple sizes or multiple version of the product. For example, a three-count microwave popcorn has a unique unit price vs. a six count microwave popcorn. Prices need to be reviewed individually, since an average price of a three and six count won't offer any insights (without more work) as to what is going on with unit price at the shelf.

After the query has been generated, the ad hoc tool accesses the data 693, as requested in the user-defined query, from the database. The extracted data is then presented to the user 694. Finally, the ad hoc module queries whether the user has requested additional analysis 695. If additional analysis has been requested, the analysis module is accessed in 696. Otherwise, control is passed to continue current operational flow.

As illustrated in FIG. 6, the analysis module is available from within the ad hoc module, and it should further be understood that the analysis module is available from all modules provided in the marketing data presentation and analysis system. In this manner, the analysis module may supply the user with additional information and analysis so as to allow the user to better understand the data and reports provided by the marketing data presentation and analysis system. By electronically linking the analysis module to the other modules comprising the marketing report system, such as for example the ad hoc module, the user is provided easy access to additional information.

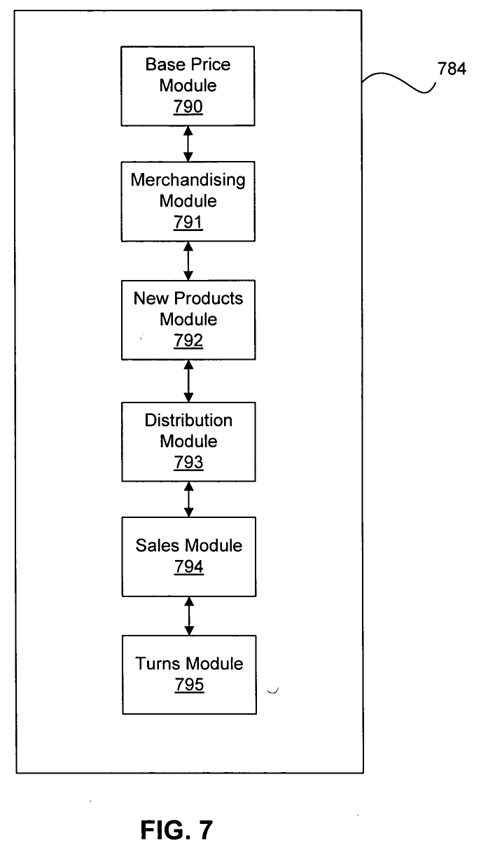

An exemplary embodiment of an information module 784 is provided in FIG. 7, including a base price module 790, a merchandising module 791, a new products module 792, a distribution module 793, a sales module 794, and a turns module 795. Each of the modules provided within the information module 784 assists the user of the marketing data presentation and analysis system to further define, identify, and resolve issues that may be presented as a result of the user's lack of understanding of the marketing data provided.

The base price module 790 includes information regarding the pricing of one or more products relevant to the user. For example, the base price module 790 may include information regarding unit pricing and may also aid the user in comparing a competitor's unit prices to the user's unit prices, as well as such issues as comparing the prices across products of varying sizes and quantities.

The merchandising module 791 includes information regarding promotional activities for the user. For example, such information as current promotional activities as well as displays run may be provided.

In new products module 792, information regarding new products may be included. For example, this module may supply such information as how to evaluate the success of new products, including how to compare the new product's release to anticipated performance.

In distribution module 793, information regarding the distribution of products to the end consumer is provided. This module may explore all the variables associated with distribution of product to consumers.

In sales module 794, information may be provided regarding the different indicators of the sales for a product, as well as how to interpret these important indicators. For example, information may be provided as to the different methods that can be used to examine sales.

Finally, in turns module 795, information is provided so as to allow the user to compare and contrast different brands provided in different distribution channels. For example, the user may find information on how to compare a local brand's sales against a national brand's sales so as to identify the better performer.

The information provided in each of the modules of the information module 784 may be generalized marketing information of general applicability to a user's business, and may further include information specifically tailored to the user's business. In either case, the modules function to provide detailed information to assist the user in interpreting and using the information provided by the marketing report system. It should be understood by one skilled in the art that modules in addition to 790-795 may be included within information module 784, and further that one or more modules may be eliminated if not relevant for to specific user.

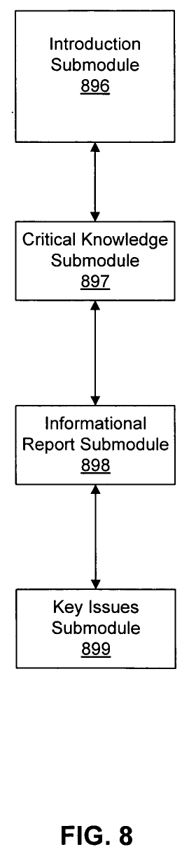

As illustrated in FIG. 8, each of the modules 790-795 of information module 784 may be configured to include sub modules including an introduction sub module 896, a critical knowledge submodule 897, an informational report submodule 898, and a key issues submodule 899. Sub modules 896-899 function to structure each of the modules 790-795 of information module 784 so as to detail the necessary information for the user to understand and interpret the marketing data information provided. It should be further noted that, within each of the submodules 896-899, electronic links for access to the analysis module are provided.

In introduction submodule 896, a general introduction to the subject matter of the information module is provided. The introduction submodule 896 describes the topic, its applications, and its vocabulary. For example, for the base price module 790, general information regarding product pricing is provided in the introduction submodule 896.

In the critical knowledge submodule 897, items are provided that a user must know in order to accurately analyze, describe, and present the marketing data provided. For example, within the base price module 790, the critical knowledge, sub module 897 includes such information as how to appropriately compare pricing for individual products, as well as how to compare pricing for products of different sizes. The critical knowledge submodule 897 functions to educate and provide the user with a critical base of knowledge for each of the areas within the information module.

The informational report submodule 898 defines what the one or more reports generated actually do, how the reports look, as well as assists the user in running desired reports. The informational report submodule 898 includes links to external applications that access marketing data from a database to provide basic information on the topic. For example, in the base price module, the informational report submodule 898 may provide information regarding what a pricing report contains, how a pricing report may look, as well as information that allows the user to run such a pricing report.

Finally, in the key issues submodule 899, an initial set of key issues are defined so as to assist the user in defining the issues that may be confronting the user's business. A key issue provided in the key issues submodule 899 may be presented in the form of a question, so as to assist the user in defining the correct questions to ask. The key issues submodule 899 further provides information so as to allow the user to obtain the data implicated by the key issues statement as well as charting information so as to allow the user to graphically represent the data obtained, and further provide analysis tips to aid the user in analyzing and presenting the data.

For example, in the base price module 790, one of the key issues supplied is: “What is my current price? What is the competition's price?” Within this key issue, the current prices of the user and of the competitor may include information so as to define extraction of the relevant data including market, period, product, and fact; sample charts so as to present the data extracted including table, bar chart, map, and thermometer; and analysis tips so as to aid the user in analyzing the data extracted and charts created.

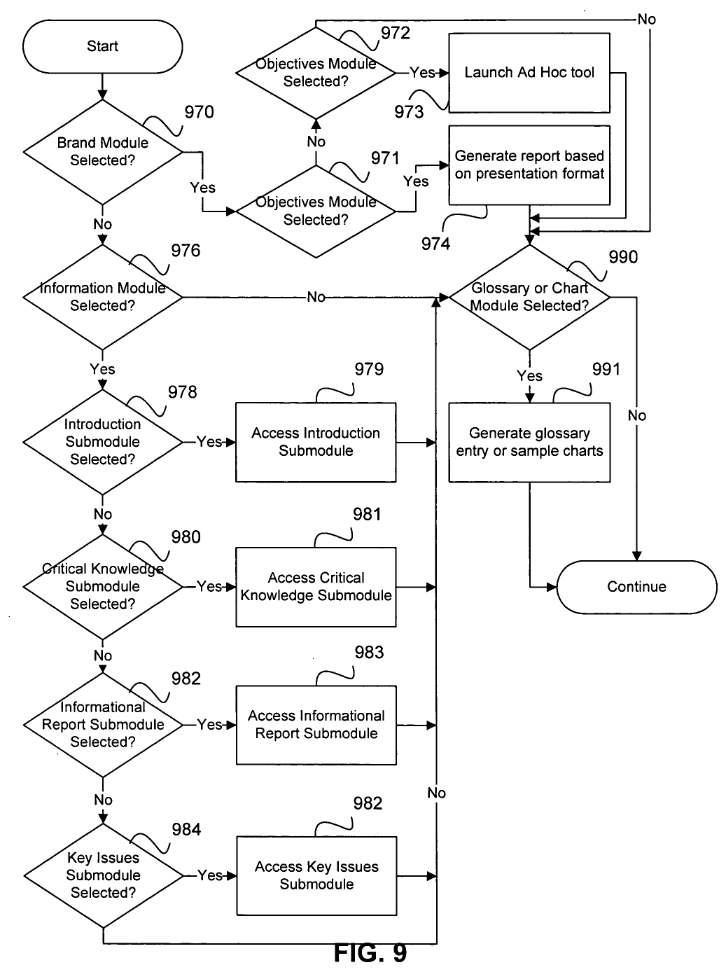

An exemplary, logical flow for an example marketing report system according to the present invention is depicted in FIG. 9. It should be understood that this flow diagram is provided by example only, and other logical operations may be added or removed, as well as the operations shown performed in different arrangements, from that as illustrated in FIG. 9.

The logical flow initiates in operation 970, wherein the marketing report system determines whether a brand module has been selected. If a user has selected a brand module, control is passed to operation 971, and the marketing data presentation and analysis system queries whether an objectives module has been selected. If an objectives module has been selected, control is passed to operation 974, and a marketing report is generated based on a presentation format. If an objectives module has not been selected, control is passed to operation 972, and the marketing data presentation and analysis system queries whether the ad hoc module has been selected. If the ad hoc module has been selected, control is passed to operation 973 and the ad hoc tool is launched, thereby allowing the user to initiate one or more ad hoc queries. However, if operation 972 determines that the ad hoc module has not been selected, control is passed to operation 990.

If the brand module has not been selected, control is passed from operation 970 to operation 976, wherein the marketing report system determines whether the information module has been selected. If the information module has not been selected, control is passed to operation 990. If the information module has been selected, control is passed to operation 978, wherein the marketing data presentation and analysis system determines whether the introduction submodule has been selected. If the introduction submodule has been selected in operation 978, control is passed to operation 979 and the introduction module provides an introduction. However, if the introduction submodule in operation 978 has not been selected, control is passed to operation 980 and a determination is made whether the critical knowledge submodule has been selected. If the critical knowledge submodule has been selected, control is passed to operation 981, and critical knowledge useful to the user is provided. However, if the critical knowledge submodule has not been selected, control is passed from operation 980 to operation 982, and the marketing data presentation and analysis system queries whether the informational report submodule has been selected. If the informational report submodule has been selected, control is passed to operation 983 and information related to one or more relevant reports is provided including the function of the report, how the report looks, as well as information on how to run the report. Finally, if the informational submodule has not been selected in operation 982, control is passed to operation 984 and the marketing data presentation and analysis module determines whether the key issue submodule has been selected. If the key issue submodule has been selected, control is passed to operation 985 and the key issues associated with the relevant information module entry are provided including data extraction, analysis, and sample charts.

Control is then passed from the information module or associated submodule of the information module to operation 990. In operation 990, the marketing report system queries whether the glossary module or chart module have been selected. If the marketing report system determines that either has been selected, control is passed to operation 991, and the marketing report system generates the appropriate glossary entry or sample chart information. Otherwise, operational flow continues. It should be noted that the glossary module and the chart module may be accessed from all operational paths as shown in FIG. 9. In this manner, the user may be further educated and assisted in understanding the information provided by the marketing data presentation and analysis system through this efficient method of providing electronic links from the data supplied to the analysis module.

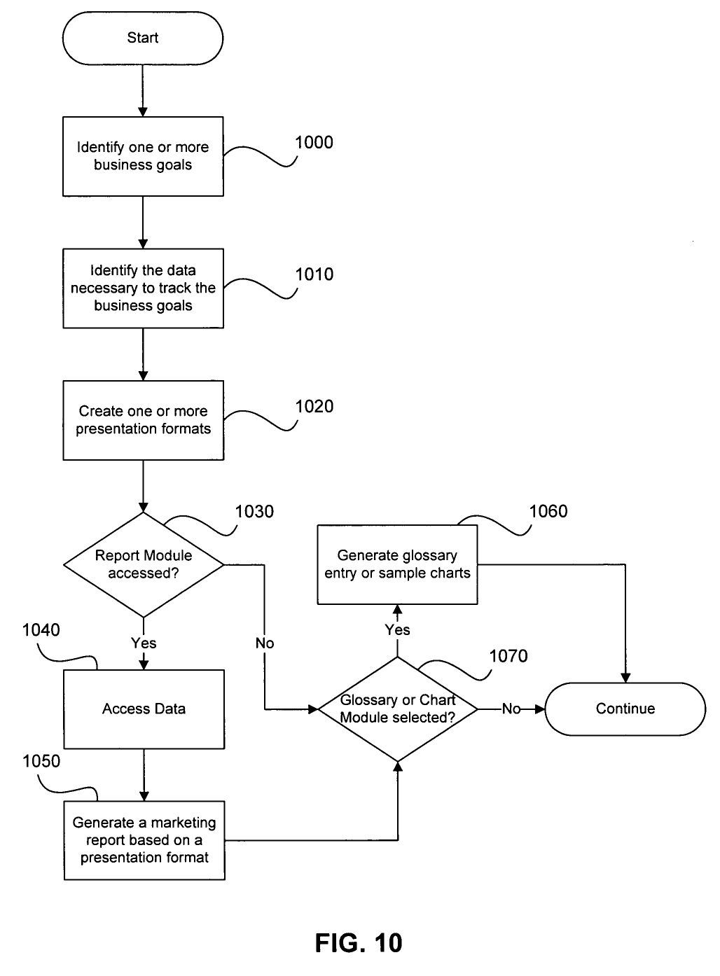

In FIG. 10, the operational flow for a business objectives module such as 380 illustrated in FIG. 3 is shown in accordance with an exemplary embodiment of the invention. Flow is initiated in operation 1000, wherein one or more business objectives are defined by the user. In operation 1010, the marketing data necessary to track the business objectives identified are defined and the necessary queries to extract such marketing data from one or more databases is created. In Operation 1010, the marketing data necessary to track the business objectives identified are defined. The necessary queries to extract such marketing data from one or more databases have been created using the rules and logic (laid out in the tool) to do a correct query. The actual query will be made using the specific requirements of the query tool that may be proprietary or a generic ad-hoc SQL tool. In operation 1020, one or more presentation formats are created. A presentation format is a template that is tailored to each individual's objectives and is used to generate the marketing report when one or more of the business objectives are accessed by the user. For example, the presentation format may consist of the hypertext marked up language (HTML) necessary to query the relevant database, as well as present the data extracted, along with other relevant marketing information, in the report. However, the tool will output in HTML, PowerPoint, Excel or any other format that is appropriate to the user environment. The tool is designed around an open architecture principal; input is based on whatever is appropriate to the customer sight, and the output is also equally “open” and will be directed to the appropriate end-user software package such as Excel, PowerPoint, Word or any other desired form.

It should be understood by one skilled in the art that other methods of creating a presentation format other than utilizing a HTML may be used without departing from the scope of the invention. For example, the marketing report system may utilize other computer languages such as C, C++, PASCAL, Java, or other such languages to implement the invention.

Once a presentation format has been created, the marketing report system determines whether the report module has been accessed in operation 1030. If the report module has not been accessed, control is passed to operation 1070. However, if the report module has been accessed, control is passed to operation 1040 and the relevant data is extracted from the one or more databases provided. Control is then passed to operation 1050, and a marketing report is generated based on the presentation format defined. Finally, control is passed to operation 1070, wherein the marketing report system determines whether the glossary module or chart module have been selected. If either has been selected, control is passed to operation 1060, wherein the relevant glossary entry or sample charts are provided. Operation is then continued.

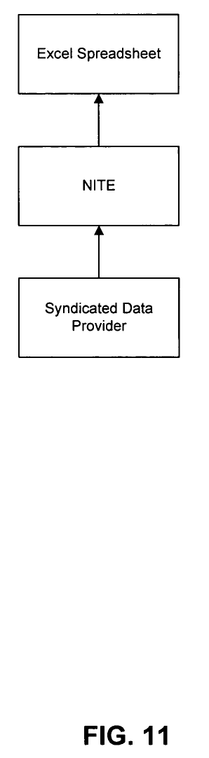

In FIG. 11, a method is provided wherein the marketing report system may extract data from the one or more databases generated and maintained by one or more third parties. This will be done through the pre-coding of appropriate queries based on the business objectives of interest. The structure of the queries will depend on and the nature of the database to be queried.

There are several advantages to the present invention as illustrated by the exemplary embodiments provided above. First, the marketing report system according to the present invention provides an efficient method whereby one or more users may access relevant marketing data as needed. The business objectives contained within the objectives module may be formulated so as to clearly define and assist a user in obtaining data relevant to the user's business objectives. Second, the marketing report system further educates and assists the user in understanding the marketing data and the information provided by the marketing report system. The marketing report system accomplishes this by first providing an analysis module including a glossary module and chart module, wherein the glossary module provides a plurality of definitions of the various marketing terms used within the marketing report system, and the chart module provides information regarding marketing charts. Further included is the information module, wherein the information module provides information including an introduction, critical knowledge, reports, and key issues concerning relevant areas of the marketing field. Third, access to the analysis module and information module is efficiently provided via one or more electronic links between these modules and the marketing report so as to allow the user to efficiently switch between them. Fourth, the marketing report system according to the present invention further provides flexibility to allow the user to formulate additional queries according to the information provided and further utilize the ad hoc module to implement those queries.

The embodiments of the invention described herein are implemented as logical steps in one or more computer systems. The logical operations of the present invention are implemented (1) as a sequence of processor-implemented steps executing in one or more computer systems and (2) as interconnected machine modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

The above specification, examples and data provide a complete description of the structure and use of exemplary embodiments of the invention. Since many embodiments of the invention can be made without departing from the spirit and scope of the invention, the invention resides in the claims hereinafter appended.

We claim:

1. A computer system implemented method of preparing and presenting marketing data in a customized format to users of marketing data, the method comprising the steps of:
selecting a presentation format for use in creating a marketing report;
storing user identified marketing data selectively extracted from a marketing database in a memory of the computer system;
processing the user identified marketing data to generate a marketing report using the selected presentation format;
wherein the marketing report generated includes at least one electronic link to an analysis module comprised of a marketing glossary and chart gallery, wherein the analysis module educates and aids the user in interpreting and using the information displayed on the marketing report.

2. The method of claim 1, further comprising identifying at least one user business objective to dictate selection of the presentation format.

3. The method of claim 1, further comprising the step of:
accessing the marketing database so as to allow the user to conduct at least one query.

4. The method of claim 1, further comprising the step of coupling an information module to the final report via at least one additional electronic links.

5. The method of claim 4, further comprising the step of generating the information module based on relevant marketing inquiries including base price, merchandising, new products, distribution, sales, and turns.

6. The method of claim 5, further comprising the step of defining the information module by creating at least one electronic link to an introduction submodule, a critical knowledge submodule, a report submodule, and a key issues submodule.

7. A computer system for manipulating marketing data and educating a user of the marketing data, the computer system comprising:
an extractor module for obtaining select marketing data from a data store;
an analysis module, the analysis module comprising a glossary and a chart gallery, and wherein the analysis module educates and aids the user in interpreting and using the select marketing data; and
a presentation module coupled to the extractor module, the presentation module including at least one electronic link to the analysis module, and wherein the select marketing data is manipulated by the presentation module to create a final report.

8. The computer system of claim 7, wherein the final report comprises:
at least one visual representation of the select marketing data; and
explanatory text describing the at least one visual representation.

9. The computer system of claim 7, further comprising an information module coupled to the presentation module, the information module including general marketing information to further educate the user.

10. The computer system of claim 9, wherein the information module comprises at least one submodule selected from the group consisting of a base price submodule, a merchandising submodule, a new products submodule, a distribution submodule, a sales submodule, and a turns submodule.

11. The computer system of claim 9, wherein the at least one submodule of the information module each include an introduction module, a critical knowledge module, a report module, and a key issues module.

12. The computer system of claim 11, wherein the introduction module, the critical knowledge module, the report module, and the key issues module each include at least one electronic link to the analysis module.

13. The computer system of claim 11, wherein the critical knowledge module further comprises at least one component that assist the user in developing a baseline understanding of relevant marketing concepts.

14. The computer system of claim 11, wherein the report module comprises at least one report and an explanation to aid the user in using the at least one report.

15. The computer system of claim 11, wherein the key issues module further comprises at least one key question formed so as to intuitively instruct the user as to how to formulate at least one inquiry.

16. The computer system of claim 15, wherein the at least one key question comprises:
a data pull submodule, wherein the data pull submodule educates the user as to how to formulate at least one query for obtaining additional marketing data from the data store;
an analysis tips submodule, wherein the analysis tips submodule aides the user in analyzing the data pull submodule; and
a sample charts submodule, wherein the sample charts module provides at least one chart;
wherein the data pull submodule, the analysis tips submodule, and the sample charts submodule are all electronically linked to the analysis module.

17. The computer system of claim 7, wherein the configuration of the final report is generated from a identified business objective of the user.

18. A method for manipulating and presenting marketing data using a computer and educating a user about the marketing data, the method comprising the steps of:
creating a business objectives module comprising query language, explanatory text, and at least one electronic link to an analysis store;
building the analysis store so as to include a glossary and a chart gallery, wherein the analysis store educates the user as to understanding and using the business objectives module;
interlinking the glossary and chart gallery;
extracting relevant marketing data from a database according to the query language upon the user electronically accessing the business objectives module; and
processing the relevant marketing data to create at least one visual representation of the relevant marketing data within the business objectives module.
